(19) United States
(12) Patent Application Publication
(10) Pub. No.: US 2018/0337709 A1
(43) Pub. Date: Nov. 22, 2018

(54) TECHNIQUES FOR GROUPING IN MU-MIMO SYSTEMS BASED ON LIMITED PROBING

(71) Applicant: QUALCOMM Incorporated, San Diego, CA (US)

(72) Inventors: Chao ZOU, San Jose, CA (US); Ahmed Ragab ELSHERIF, San Jose, CA (US); Hao ZHU, Milpitas, CA (US); Srinivas KATAR, Fremont, CA (US)

(21) Appl. No.: 15/599,971

(22) Filed: May 19, 2017

(51) Int. Cl. H04B 7/024; H04B 7/0452; H04L 1/00; H04W 88/06; H04W 24/08; H04L 25/08

(52) U.S. Cl. CPC H04B 7/024; H04B 7/0452; H04L 25/08; H04W 88/06; H04W 24/08; H04L 1/0048

(57) ABSTRACT

The present disclosure provides techniques for grouping in multi-user multiple-input-multiple-output (MU-MIMO) systems by using limited probing. With more wireless stations (STAs) being used in MU-MIMO groups, the probing used to obtain packet error metrics to determine the throughput for selecting the MU-MIMO groups for transmission can become more complex and involve a larger overhead. To reduce the probing overhead, various techniques are described in this disclosure. For example, an access point (AP) can identify a trigger to initiate a packet error probing. In response to the trigger, the AP embeds one or more probing packets that are part of the packet error probing within a short interframe space (SIFS)-burst data transmission process to take advantage of the existing structure of the process. Then, the AP can update at least one packet error metric (e.g., packet error rate or PER) based on feedback received in response to the probing packets.

### BACKGROUND

The present disclosure relates generally to wireless communications systems, and more particularly, to techniques for grouping in multi-user multiple-input-multiple-output (MU-MIMO) systems based on limited probing.

The deployment of wireless local area networks (WLANs) in the home, the office, and various public facilities is commonplace today. Such networks typically employ an access point (AP) that connects a number of wireless stations (STAs) in a specific locality (e.g., home, office, public facility, etc.) to another network, such as the internet or the like. A set of STAs can communicate with each other through a common AP in what is referred to as a basic service set (BSS).

As the number of STAs deployed in such networks grows, techniques that provide more effective MU-MIMO communications are desirable. For example, with the introduction of up to eight (8) STAs in an MU-MIMO group for the Institute of Electrical and Electronics Engineers (IEEE) 802.11ax standard, where previous standards such as IEEE 802.11ac used up to four (4) STAs instead, the number of different possible MU-MIMO groups scheduled for transmission can be significantly higher. In order to obtain packet error information (e.g., packet error rate or PER) for different STAs in different MU-MIMO groups to determine which MU-MIMO groups are best for transmission, the AP may need to perform extensive probing operations to obtain the appropriate information. In the past such probing was only necessary for MU-MIMO groups constructed with up to 4 STAs, such that probing overhead was not much of a concern. Now, with up to 8 STAs in an MU-MIMO group, probing operations can result in significant amounts of overhead.

The right amount of probing involves a tradeoff between overhead and accuracy. The more probing that is done, the more accurate the packet error information collected and the better selection of MU-MIMO groups for transmission (e.g., more effective MU-MIMO grouping). This approach, however, can result in much larger overhead, reducing the efficiency of the MU-MIMO communications. On the other hand, the less probing that is done, the more efficient the MU-MIMO communications because of the lower overhead. This other approach, however, tends to provide less accurate packet error information and a less than optimal selection of MU-MIMO groups for transmission (e.g., less optimal MU-MIMO grouping).

Accordingly, it is desirable to have more efficient probing operations that reduce the probing overhead and still allow the collection of accurate information to perform effective scheduling of MU-MIMO groups for MU-MIMO communications in WLANs.

### SUMMARY

The present disclosure provides aspects related to techniques for MU-MIMO communications, and more specifically, to techniques for grouping in MU-MIMO systems based on limited probing. The techniques described herein include the reduction in probing overhead by embedding the probing operation into a regular short interframe space (SIFS)-burst data transmission process. This approach allows for the probing operation to take advantage or share at least part of the existing communication signaling structure of the SIFS-burst data transmission process to reduce overhead. Other techniques include the selection of MU-MIMO group sizes and MU-MIMO groups that have the potential to be optimal MU-MIMO groups sizes and MU-MIMO groups for probing because of various considerations in their selection. These techniques can involve the selection of candidate STAs, as well as the selection of candidate modulation coding schemes (MCSs). Yet other techniques include the use of channel correlation to help reduce the number of MU-MIMO groups for probing. Yet other techniques include the use of heuristics to update packet error metrics (e.g., PER) for those MU-MIMO group sizes not probed as part of the probing operation such that those MU-MIMO group sizes have information considered sufficiently reliable for an AP to make determinations as to the viability of those non-probed MU-MIMO group sizes for scheduling MU-MIMO communications.

In one example, a method of MU-MIMO communications is disclosed. The method includes identifying, at an AP, a trigger to initiate a packet error probing. The method can also include transmitting, as part of the packet error probing and in response to the identification of the trigger, one or more probing packets within a SIFS-burst data transmission process, the one or more probing packets being transmitted before transmission of data packets in the SIFS-burst data transmission process. In addition, the method can include updating at least one packet error metric based on feedback received in response to the one or more probing packets.

In another example, an apparatus for MU-MIMO communications is disclosed. The apparatus includes a memory that stores MU-MIMO communications instructions, and a processor coupled with the memory. The processor can be configured to execute the MU-MIMO communications instructions to identify, at an AP, a trigger to initiate a packet error probing. The processor can also be configured to transmit (e.g., via a transceiver), as part of the packet error probing and in response to the identification of the trigger, one or more probing packets within a SIFS-burst data transmission process, the one or more probing packets being transmitted before transmission of data packets in the SIFS-burst data transmission process. In addition, the processor can be configured to update at least one packet error metric based on feedback received in response to the one or more probing packets.

In yet another example, an apparatus for MU-MIMO communications is disclosed. The apparatus includes means for identifying, at an AP, a trigger to initiate a packet error probing. The apparatus can also include means for transmitting, as part of the packet error probing and in response to the identification of the trigger, one or more probing packets within a SIFS-burst data transmission process, the one or more probing packets being transmitted before transmission of data packets in the SIFS-burst data transmission process. In addition, the apparatus can include means for updating at least one packet error metric based on feedback received in response to the one or more probing packets.

In yet another example, a computer-readable medium (e.g., a non-transitory computer-readable medium) storing executable code for MU-MIMO communications is disclosed. The code includes code for identifying, at an AP, a trigger to initiate a packet error probing. The code can also include code for transmitting, as part of the packet error probing and in response to the identification of the trigger, one or more probing packets within a SIFS-burst data transmission process, the one or more probing packets being transmitted before transmission of data packets in the SIFS-burst data transmission process. In addition, the code can include code for updating at least one packet error metric based on feedback received in response to the one or more probing packets.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

FIG. 1 illustrates an example of a wireless communication system in which aspects of the present disclosure can be employed.

FIG. 2 illustrates an example of embedding the probing operations within a regular data transmission in connection with aspects of the present disclosure.

FIG. 3 illustrates an example of different triggers for the probing operations in connection with aspects of the present disclosure.

FIG. 4 illustrates an example of MU-MIMO group selection for the probing operations in connection with aspects of the present disclosure.

FIG. 5 illustrates an example of another aspect of MU-MIMO group selection for the probing operations in connection with aspects of the present disclosure.

FIG. 6 illustrates an example of hardware implementation of an AP that can be employed within a wireless communication system in accordance with various aspects of present disclosure.

FIG. 7 illustrates an example of hardware implementation of an STA that can be employed within a wireless communication system in accordance with various aspects of present disclosure.

FIG. 8 illustrates an example of a method for wireless communications implemented on an AP in accordance with various aspects of the present disclosure.

FIG. 9 illustrates an example of another method for wireless communications implemented on an AP in accordance with various aspects of the present disclosure.

### DETAILED DESCRIPTION

Various concepts will be described more fully hereinafter with reference to the accompanying drawings. These concepts may, however, be embodied in many different forms by those skilled in the art and should not be construed as limited to any specific structure or function presented herein. Rather, these concepts are provided so that this disclosure will be thorough and complete, and will fully convey the scope of these concepts to those skilled in the art. The detailed description may include specific details. However, it will be apparent to those skilled in the art that these concepts may be practiced without these specific details.

As discussed above, the more probing that is done to obtain accurate packet error metrics (e.g., PER) for MU-MIMO grouping, the larger the overhead and the less efficient the MU-MIMO communications. On the other hand, the less probing that is done, the more efficient the MU-MIMO communications because of the lower overhead, but the MU-MIMO grouping can become less than optimal. To address this issue, the present disclosure provides multiple techniques, which can be applied independently or in combination with one another, to reduce the overhead that would otherwise be needed to obtain accurate packet error metrics information for MU-MIMO grouping when the MU-MIMO groups can have many more STAs than was possible in the previous standards. In this regard, limited probing as used in this disclosure may refer to the use of efficient probing operations based on the techniques described herein.

In a typical MU-MIMO grouping operation, an AP needs to iterate through all possible MU-MIMO group sizes and selects the sizes and group members (e.g., STAs) that would result in a best throughput score. The best throughput score generally refers to a predicted data throughput, sometimes referred to as goodput. For a particular MU-MIMO group size (gs), the predicted data throughput (PDT) can be calculated based on equation (1), which is shown below:

$${PDT}_{gs} = \frac{{\sum }_{i ∈ Ggs} {T}_{i} \times {R}_{i} ( MCS ) \times ( 1 - {PER}_{i} ( gs , MCS ) )}{{T}^{*} + {OH}_{gs}} , \qquad ( 1 )$$

where PDT_{gs} is a predicted data throughput or goodput for an MU-MIMO group of size gs, T* is a total transmission time associated with an MU-MIMO group of size gs, OH_{gs} is an overhead time associated with data transmissions for an MU-MIMO group of size gs, Ggs is a subgroup or subset of the MU-MIMO group candidates, Tᵢ is a predicted transmission time (e.g., based on buffer status) associated with an STA(i) (or spatial stream(i)), Rᵢ is a predicted data transmission rate, or PHY-rate, associated with an STA(i) (or spatial stream(i)) for a given MCS, and PERᵢ is a packet error rate for an STA(i) (or spatial stream(i)) with an MU-MIMO group of size gs and for a given MCS. Additional details and/or other examples for determining the PDT or throughput score for MU-MIMO grouping are described in commonly-owned, co-pending U.S. patent application Ser. No. 15/365,751 filed on Nov. 30, 2016 and entitled “Multi-User Multiple-Input-Multiple-Output Group Management,” the contents of which are incorporated here by reference in their entirety.

As shown in equation (1), the throughput score relies on the value of PER, or other similar packet error metrics, for the different MU-MIMO group sizes being considered. Accordingly, an AP needs to maintain packet error metric information updated in order to make the most reliable calculations of the throughput score and therefore be able to perform optimal MU-MIMO grouping for efficient MU-MIMO communications. As a result, the AP performs probing operations to obtain, process (e.g., average), and store up-to-date packet error metrics information.

In earlier standards, such as IEEE 802.11ac standard, for example, the MU-MIMO group had a maximum of 4 STAs, with various implementations using no more than 3 STAs. With up to 3 or 4 STAs in an MU-MIMO group, an AP could probe the packet error metrics for all MU-MIMO groups to find the best MU-MIMO group size and members. With the advent of IEEE 802.11ax, for example, having an MU-MIMO group with a maximum of 8 STAs, the number of possible combinations that an AP would need to probe to collect accurate packet error information would be very large, particularly for dense WLANs with many STAs. In such situations, the probing operations could have a very large overhead if the AP were to probe too many MU-MIMO groups. Instead, the AP would likely select only a portion of the possible MU-MIMO group sizes to probe for packet error metrics, and even for those selected MU-MIMO group sizes, the packet error metrics of only a portion are likely to be updated.

The present disclosure describes techniques for reducing the overhead in probing operations, identify MU-MIMO group sizes and MU-MIMO groups that are most likely to provide effective updates to packet error metrics information, and introduce heuristics to update packet error metrics information for MU-MIMO group sizes that were not probed as part of the probing operations. These techniques include, but are not limited to, embedding the probing operation into a regular SIFS-burst data transmission process. This approach allows for the probing operation to take advantage or share at least part of the existing communication signaling structure of the SIFS-burst data transmission process to reduce overhead. Other techniques include the selection of MU-MIMO group sizes and MU-MIMO groups that have the potential to be optimal MU-MIMO groups sizes and MU-MIMO groups for probing because of various considerations in their selection. These techniques can involve the selection of candidate STAs, as well as the selection of candidate MCSs. Yet other techniques include the use of channel correlation to help reduce the number of MU-MIMO groups for probing. Additional techniques include the use of strategies (e.g., heuristics) based on some of the information generated by the probing operation to update packet error metrics (e.g., PER) for those MU-MIMO group sizes not probed as part of the probing operation.

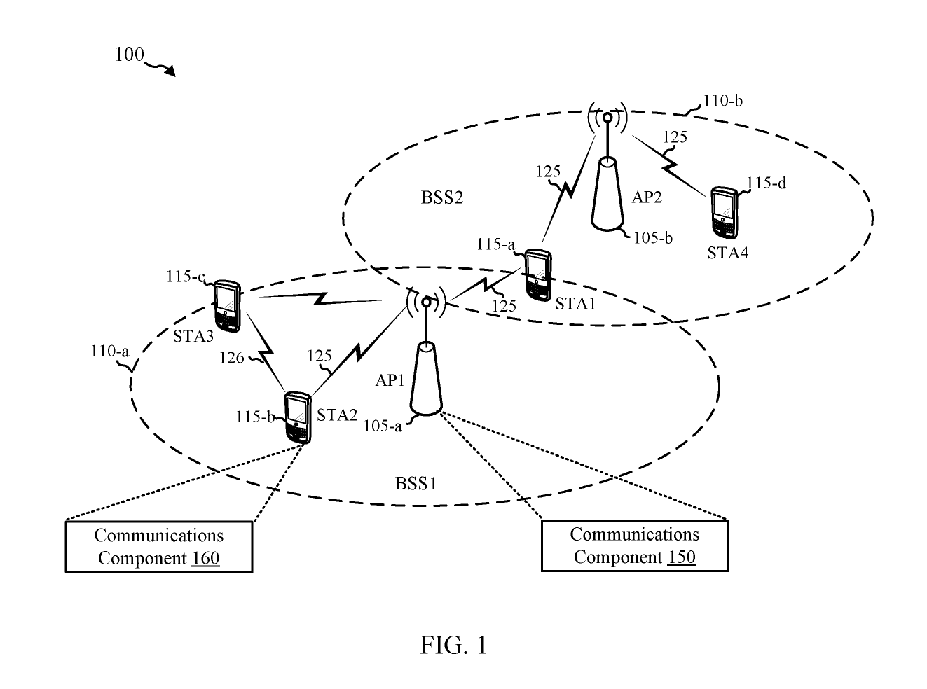

Additional details and explanations for the proposed techniques used in probing operations for MU-MIMO grouping are provided below in connection with FIGS. 1-9.

FIG. 1 is a conceptual diagram 100 illustrating an example of a WLAN deployment in connection with various techniques described herein for grouping in MU-MIMO systems based on limited probing. The WLAN may include one or more APs and one or more wireless stations or STAs associated with a respective AP. In this example, there are two APs deployed: AP1 105-a in basic service set 1 (BSS1) and AP2 105-b in BSS2, which may be referred to as an overlapping BSS or OBSS. AP1 105-a is shown as having at least three associated STAs (STA1 115-a, STA2 115-b, and STA3 115-c) and coverage area 110-a, while AP2 105-b is shown having one associated STA4 115-d and coverage area 110-b (STA1 115-a is within the coverage area 110-b of AP2 105-b and could be associated with AP2 105-b). The STAs 115 and AP 105 associated with a particular BSS may be referred to as members of that BSS. In the example of FIG. 1, the coverage area of AP1 105-a can overlap part of the coverage area of AP2 105-b such that STA1 115-a can be within the overlapping portion of the coverage areas. The number of BSSs, APs, and STAs, and the coverage areas of the APs described in connection with the WLAN deployment of FIG. 1 are provided by way of illustration and not of limitation.

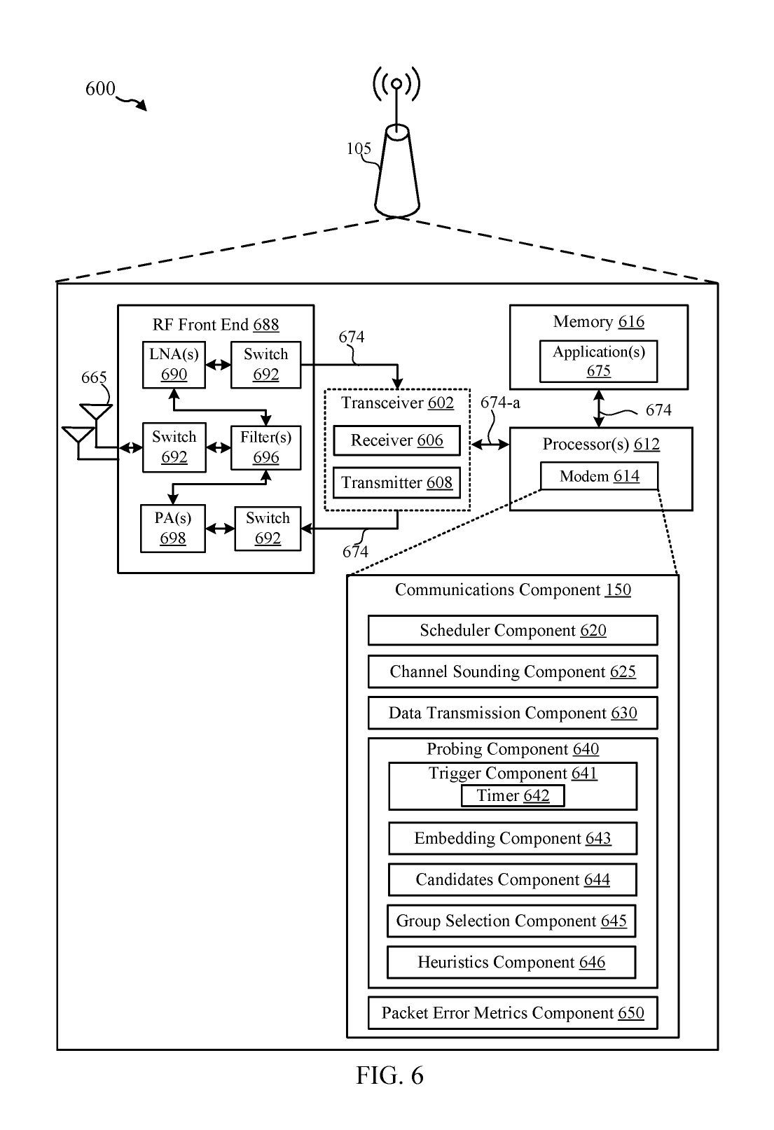

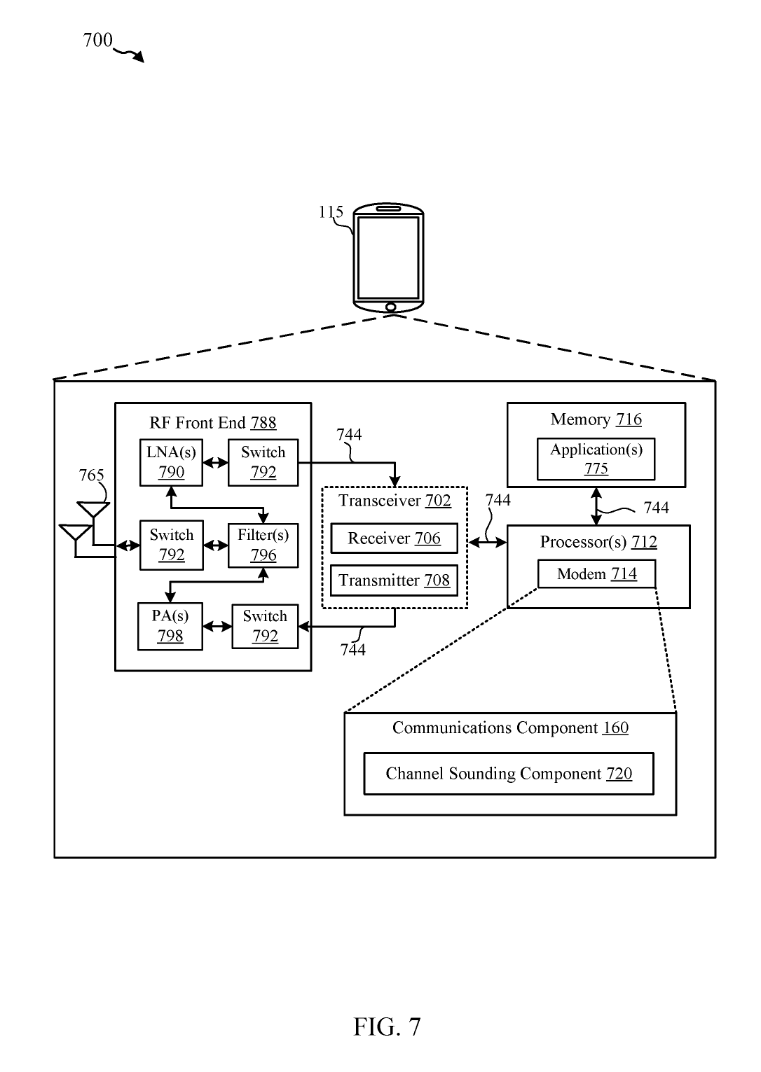

As described above, an AP, such as AP1 105-a or AP2 105-b can communicate with multiple STAs 115 using MU-MIMO communications techniques. When the IEEE 802.11ax standard is supported in such communications, an AP can have as many as eight (8) STAs join in an MU-MIMO group for transmission using an MU-MIMO physical layer convergence protocol (PLCP) packet data unit, also referred to as an MU-MIMO PPDU, an MU-PPDU, or simply a PPDU. In the example shown in FIG. 1, AP1 105-a can have STA1 115-a, STA2 115-b, STA3 115-c, and up to five other STAs 115 in an MU-PPDU. To optimize MU-MIMO communications with multiple STAs, the AP1 105-a can include a communications component 150 (see e.g., FIG. 6) that is configured to perform aspects of the various techniques for MU-MIMO grouping with limited or reduced probing proposed in this disclosure. Similarly, an STA 115 communicating with the AP1 105-a, such as the STA2 115-b, for example, can include a communications component 160 (see e.g., FIG. 7) that is configured to provide information needed by the AP1 105-a (e.g., channel estimates in compressed beamforming (CBF) reports) to perform aspects of the various techniques for MU-MIMO grouping with limited or reduced probing proposed in this disclosure.

In some examples, the APs (e.g., AP1 105-a and AP2 105-b) shown in FIG. 1 are generally fixed terminals that provide backhaul services to STAs 115 within its coverage area or region. In some applications, however, the AP may be a mobile or non-fixed terminal. The STAs (e.g., STA1 115-a, STA2 115-b, STA3 115-c, STA4 115-d) shown in FIG. 1, which can be fixed, non-fixed, or mobile terminals, utilize the backhaul services of their respective AP to connect to a network, such as the internet. Examples of an STA include, but are not limited to: a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, a device for the Internet-of-Things (IoT), a wearable device, or any other suitable wireless apparatus requiring the backhaul services of an AP. An STA may also be referred to by those skilled in the art as: a subscriber station, a mobile unit, a subscriber unit, a wireless unit, a remote unit, a mobile device, a wireless device, a wireless communications device, a remote device, a mobile subscriber station, an access terminal, a mobile terminal, a wireless station, a remote terminal, a handset, a user agent, a mobile client, a client, a user equipment (UE), a wearable device, or some other suitable terminology. An AP may also be referred to as: a base station, a base transceiver station, a radio base station, a radio transceiver, a transceiver function, a wireless or Wi-Fi hotspot, or any other suitable terminology. The various concepts described throughout this disclosure are intended to apply to all suitable wireless apparatus regardless of their specific nomenclature.

Each of STA1 115-a, STA2 115-b, STA3 115-c, and STA4 115-d can be implemented with a protocol stack. The protocol stack can include a physical layer for transmitting and receiving data in accordance with the physical and electrical specifications of the wireless channel, a data link layer for managing access to the wireless channel, a network layer for managing source to destination data transfer, a transport layer for managing transparent transfer of data between end users, and any other layers necessary or desirable for establishing or supporting a connection to a network.

Each of AP1 105-a and AP2 105-b can include software applications and/or circuitry to enable associated STAs to connect to a network via communications link 125. The APs can send frames or packets to their respective STAs and receive frames or packets from their respective STAs to communicate data and/or control information (e.g., signaling). As described above, communications between an AP and multiple STAs can include MU-MIMO communications, which include the transmission of MU-MIMO PPDUs (or referred simply as MU-PPDUs or PPDUs), and which can support WLAN standards such as the IEEE 802.11ax standard as well as other legacy standards (e.g., IEEE 802.11ac). As part of these MU-MIMO communications, an AP can perform the MU-MIMO grouping using the probing operations described herein.

Each of AP1 105-a and AP2 105-b can establish a communications link 125 with an STA that is within the coverage area of the AP. Communications link 125 can comprise communications channels that can enable both uplink and downlink communications. When connecting to an AP, an STA can first authenticate itself with the AP and then associate itself with the AP. Once associated, a communications link 125 may be established between the AP 105 and the STA 115 such that the AP 105 and the associated STA 115 may exchange frames or messages through a direct communications link 125. It should be noted that the wireless communication system, in some examples, may not have a central AP (e.g., AP 105), but rather may function as a peer-to-peer network between the STAs (e.g., STA2 115-b and STA3 115-c over communication link 126). Accordingly, the functions of the AP 105 described herein may alternatively be performed by one or more of the STAs 115.

While aspects of the present disclosure are described in connection with a WLAN deployment or the use of IEEE 802.11-compliant networks, those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. Thus, the various aspects presented throughout this disclosure for performing operations based on modifications and enhancements to MU-MIMO grouping can be applicable to any suitable wireless network regardless of the coverage range and the wireless access protocols utilized.

In some aspects, one or more APs (e.g., AP1 105-a and AP2 105-b) can transmit on one or more channels (e.g., multiple narrowband channels, each channel including a frequency bandwidth) a beacon signal (or simply a “beacon”), via a communications link 125 to STA(s) 115 of the wireless communication system, which can help the STA(s) 115 to synchronize their timing with the APs 105, or which may provide other information or functionality.

An AP (e.g., AP1 105-a) can perform various techniques for probing operations that reduce the probing overhead needed to update packet error metrics at the AP for MU-MIMO grouping. A packet error metric can refer to a measurement, a value, an index, a parameter, or the like that indicates a degree of performance in the transmission of packets. An example of a packet error metric used by way of illustration in this disclosure is the PER. Nevertheless, other types of packet error metrics can also be used in connection with the techniques described herein. A signal strength metric can refer to a measurement, a value, an index, a parameter, or the like that indicates a degree of signal strength relative to noise and/or interference. An example of a signal strength metric used by way of illustration in this disclosure is the MU signal-to-interference-plus-noise ratio (SINR) or MU-SINR. Nevertheless, other types of signal strength metrics can also be used in connection with the techniques described herein.

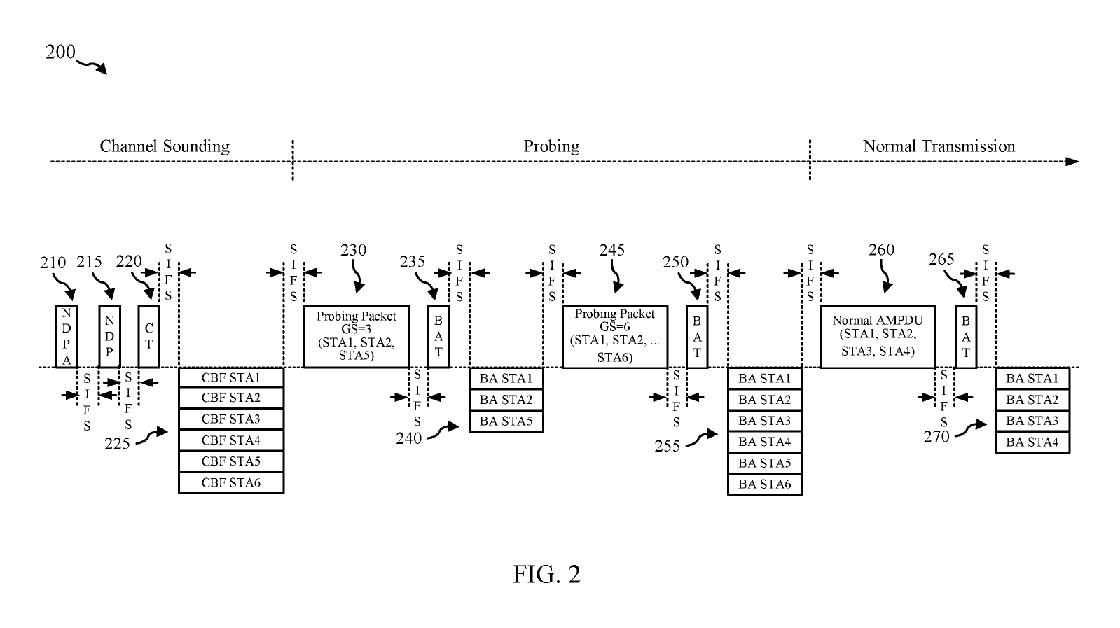

Additional details regarding the techniques with which an AP can perform efficient probing operations are described below in connection with FIGS. 2-5.

FIG. 2 illustrates an example of embedding probing operations within a regular data transmission. As shown in diagram 200, in order to reduce the probing overhead (e.g., overhead from probing to obtain packet error metrics information), the probing operation can be embedded or merged with real data transmission operations. By doing so, probing operations can take advantage of the existing framework provided by data transmission operations and need not be performed separately.

In this example, a channel sounding sequence is performed first. An AP (e.g., the beamformer) transmits a null data packet announcement (NDPA) 210, which is used to gain control of the channel and identify STAs that will receive the beamformed transmissions from the AP (e.g., the beamformees). The AP follows the NDPA 210 with the transmission of an NDP 215, which is used by the receiving STA to analyze training fields to calculate the channel response. In some implementations, more than one NDP 215 can be transmitted. After the NDP 215, the AP can optionally transmit a compressed beamforming (CBF) report trigger or CT 220.

In response to the NDP(s) 215 (and/or the CT 220), the STAs targeted by the AP for channel sounding send feedback to the AP in the form of CBF reports 225. In this example, each of STA1, STA2, STA3, . . . , STA6 (six STAs) sends back a CBF report 225 to the AP. STA1 sends back CBF STA1, STA2 sends back CBF STA2, and so on. The CBF report 225 can include channel information obtained from analyzing the training fields or other information provided in the NDP(s) 215. In an example, the channel information can include a feedback matrix, which the AP can use to generate a steering matrix. Moreover, the AP can calculate or determine channel correlation information, including correlation metrics between STAs, using signal strength metric (e.g., MU-SINR) results produced or generated from the information provided by the CBF reports 225.

With the information provided in the CBF reports 225, the AP can obtain, for example, signal strength metric information that can be used in connection with channel correlation when performing some of the techniques described herein for grouping in MU-MIMO systems with limited probing.

Once the channel sounding sequence is complete, the AP can embed or merge probing operations into the data transmission (e.g., the data transmission operations). As shown in the example described by the diagram 200, the AP transmits a first probing packet (or probe packet) 230 at the beginning of a regular short interframe space (SIFS)-burst data transmission process. The first probing packet 230 can be a PPDU, for example. The first probing packet 230 is being used to probe for MU-MIMO group size of 3 (GS=3) and MU-MIMO group members STA1, STA2, and STA5. The MU-MIMO group members associated with the first probing packet 230 were also part of the channel sounding sequence operation as they provided CBF reports 225 back to the AP. Following the transmission of the first probing packet 230, the AP optionally transmits a block acknowledgement (BA) trigger or BAT 235.

In response to the first probing packet 230 (and/or the BAT 235), the STAs targeted by the AP for packet error metric probing send feedback to the AP in the form of BAs 240. In this example, each of STA1, STA2, and STA5 sends back a BA 240 to the AP. STA1 sends back BA STA1, STA2 sends back BA STA2, and STA5 sends back BA STA5. The BAs 240 can include packet error information (e.g., PER). For example, the information in the BAs 240 can indicate how many packets sent to the STAs were successfully received and/or how many failed to be properly received (e.g., packet error).

The AP can transmit a second probing packet (or probe packet) 245 after the first probing packet 230 and within the regular SIFS-burst data transmission process. The second probing packet 245 can also be a PPDU. The second probing packet 245 is being used to probe for MU-MIMO group size of 6 (GS=6) and MU-MIMO group members STA1, STA2, STA3, STA4, STA5, and STA6. The MU-MIMO group members associated with the second probing packet 245 were also part of the channel sounding sequence operation as they provided CBF reports 225 back to the AP. Following the transmission of the second probing packet 245, the AP optionally transmits a BA trigger or BAT 250.

In response to the second probing packet 245 (and/or the BAT 250), the STAs targeted by the AP for packet error metric probing send feedback to the AP in the form of BAs 255. In this example, each of STA1, STA2, STA3, STA4, STA5, and STA6 sends back a BA 255 to the AP. STA1 sends back BA STA1, STA2 sends back BA STA2, STA3 sends back BA STA3, STA4 sends back BA STA4, STA5 sends back BA STA5, and STA6 sends back BA STA6. The BAs 255 can include packet error information (e.g., PER). For example, the information in the BAs 255 can indicate how many packets sent to the STAs were successfully received and/or how many failed to be properly received (e.g., packet error).

Once the probing operation is complete within the current SIFS-burst data transmission process, the AP can then proceed to perform normal data transmissions. For example, after the BAs 255 are sent to the AP, the AP can transmit a data packet 260. The data packet 260 shown in the example in FIG. 2 is an aggregated media access control (MAC) packet data unit or AMPDU, which aggregates or groups together several MAC PDU (or MPDU) blocks. While this example uses an AMPDU, the disclosure need not be so limited and other types of data packets can be used in this context. Following the transmission of the data packet 260, the AP optionally transmits a BA trigger or BAT 265.

In response to the data packet 260 (and/or the BAT 265), the STAs targeted by the AP send feedback to the AP in the form of BAs 270. In this example, each of STA1, STA2, STA3, and STA4 sends back a BA 270 to the AP. STA1 sends back BA STA1, STA2 sends back BA STA2, STA3 sends back STA3, and STA4 sends back BA STA4. The BAs 270 can include packet error information (e.g., PER). For example, the information in the BAs 270 can indicate how many packets sent to the STAs were successfully received and/or how many failed to be properly received (e.g., packet error).

After the transmission of the data packet 260, the AP can transmit additional data packets as part of the normal transmission the current SIFS-burst data transmission process.

Also shown in FIG. 2 are the various SIFS intervals used between transmissions to allow for enough time to process a received packet and respond where appropriate.

One difference between the technique described in FIG. 2 and regular SIFS-burst data transmission is that in regular SIFS-burst data transmission failure in the transmission of one of the data packets terminates the burst. In contrast, failure in the transmission of the first probing packet 230, the second probing packet 245, or both, does not terminate the burst and the AP can simply continue with the normal transmission of data packets.

While the example described in the diagram 200 of FIG. 2 includes two probing packets as part of the probing operation, the disclosure need not be so limited. More or fewer probing packets could be used. A larger number of probing packets can affect the overall MU-MIMO communications efficiency by increasing the probing overhead. On the other hand, fewer probing packets may not provide enough packet error metrics information to make optimal selections in MU-MIMO grouping.

As described above, and in connection with equation (1), one of the reasons for the probing operations described in this disclosure is to update information about packet error metrics (e.g., PER) in the AP so that the AP can make better MU-MIMO grouping decisions, such as which MU-MIMO group sizes and group members (e.g., STAs) would result in a best throughput score.

There can be different approaches as to how often should packet error metrics be updated. One option can be to have the AP update packet error metrics after every PPDU transmission. It is also possible to perform probing operations as a way to have additional updates. These probing operations can then target a potentially desirable MU-MIMO group size to help the AP make better informed decisions during MU-MIMO grouping as it relates to the desirable MU-MIMO group size. As described above, more frequent probing can make the packet error metrics more stable and accurate so that an AP can avoid having to switch between different MU-MIMO group sizes. More frequent probing, however, will incur higher probing overhead.

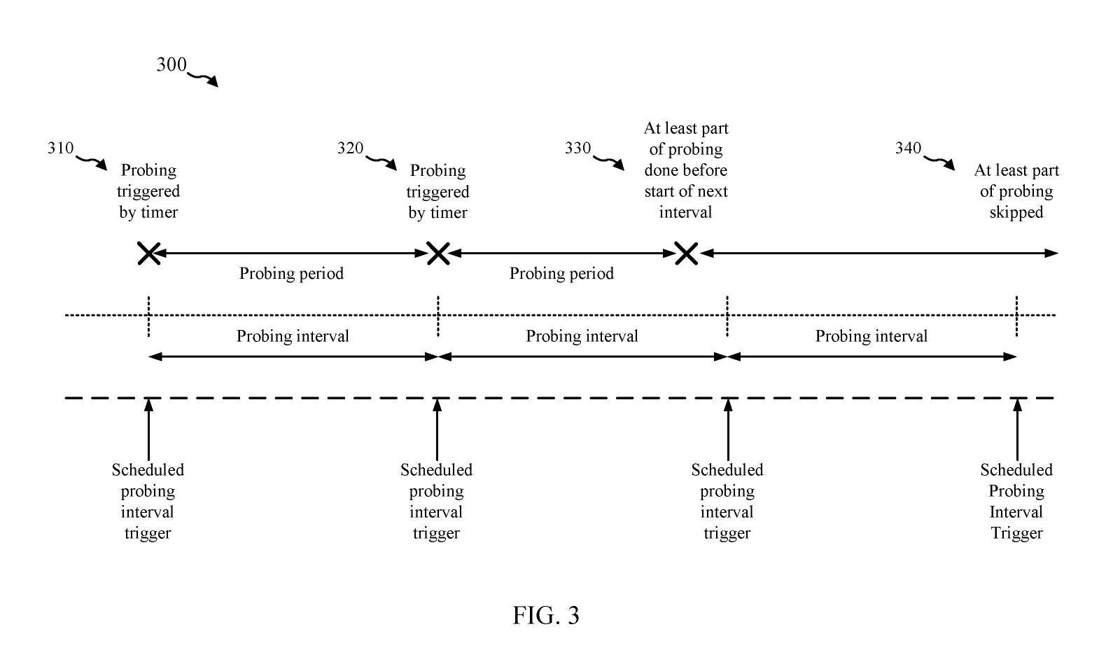

FIG. 3 illustrates a diagram 300 with different triggers for the probing operations described herein. The triggers described in the diagram 300 can be used to achieve a tradeoff between probing overhead and the accuracy and/or stability of the packet error metrics maintained by the AP. The AP can identify these triggers and can initiate probing operations in response to one of the triggers being identified. In this disclosure, the probing operations can also be referred to as packet error probing, packet error metrics probing, or PER probing when the packet error metric being considered is PER.

As shown in FIG. 3, one solution to obtain a desired tradeoff between probing overhead and accuracy/stability is to perform the probing operations when a trigger timer expires at a scheduled time. For example, the diagram 300 shows multiple probing interval triggers scheduled at particular times such that there is a same or substantially same probing interval between these triggers. In one aspect, the probing interval can be 100 milliseconds and, consequently, the probing interval triggers can be scheduled to occur every 100 milliseconds. To do so, a timer (e.g., timer 642 in FIG. 6) can be programmed to expire and trigger a scheduled probing interval every 100 milliseconds. When the timer expires, the AP can perform the probing operations for a selected set of STAs, MU-MIMO group sizes, and/or MCSs.

In FIG. 3, the diagram 300 shows that there is a probing (e.g., probing operation) triggered by a timer at 310 and another probing triggered by a timer at 320. The probing at 310 and the probing at 320 coincide with the scheduled probing interval triggers. In such a case, a probing period, that is, a time period between a start of the probing at 310 and a start of the probing at 320 is the same as the probing interval resulting from the scheduled triggers.

The AP can have mechanisms to preempt or override the interval-based or interval-driven triggering of probing operations described above. The AP can do so to get more accuracy and/or to reduce probing overhead.

For example, when the AP identifies a condition in which it continuously selects the same MU-MIMO group size (gs) for a specified period of time (e.g., by meeting a certain time threshold), and when the packet error metrics are very low (e.g., by being below a certain packet error threshold), the AP can determine to try a larger MU-MIMO group size (gs+1) even when the next scheduled probing interval trigger has not been reached (e.g., the timer has yet to expire). This is illustrated in the diagram 300 by the probing triggered at 330, which occurs just prior to the next scheduled probing interval trigger.

In another example, the AP can limit or override scheduled probing interval triggers. When certain conditions are met, probing will not be triggered even when the scheduled probing interval trigger has occurred (e.g., the timer has expired). One such condition can be when the packet error metrics for all the MU-MIMO group sizes have been updated since the last probing operation. This requires that the AP keeps track of the packet error metrics update for each MU-MIMO group size. When this condition is met, the AP can skip the next scheduled probing interval trigger (as shown at 340 in FIG. 3). Another such condition is when the packet error metrics for small MU-MIMO group sizes (e.g., gs=1 or 2) is greater than a certain threshold, in which case probing for larger MU-MIMO group sizes can be skipped since a larger number of STAs is likely to result in an even higher packet error metric due to inter-user interference. In this case, the probing need not be skipped altogether, but at least portion of it (e.g., a portion associated with the larger number of STAs) can be skipped (as shown at 340 in FIG. 3).

As part of updating the packet error metrics as described above, an AP needs to select the STA, MU-MIMO group size, and MCS to probe for the update. The AP can include one or more tables with the packet error metrics and can update the tables in response to the feedback provided by the probing operations. In one aspect, the packet error metrics are averaged over time for the same MU-MIMO group size.

As part of the techniques described herein, one of the objectives or goals is to make the packet error metrics (e.g., PER) for desirable MU-MIMO group sizes converge quickly to the real packet error metric. Another goal is to limit the desirable MU-MIMO group sizes based on channel correlation. Yet another goal is to probe MU-MIMO group sizes around or close in size to desirable MU-MIMO group sizes such that by having correct packet error metrics for those other MU-MIMO group sizes, the AP can make more accurate decisions as part of MU-MIMO grouping.

When selecting the STAs, one approach to follow is to probe those STAs for which the AP has a significant amount of data and that have a high quality-of-service (QoS) because those STAs are likely to have a high chance to be targeted receivers when performing MU-MIMO grouping. Based on this approach, there can be several options that can be followed for STA selection.

A first option is to probe (e.g., select for probing) those STAs that have the highest QoS. A second option is to probe those STAs that have the highest scheduled transmit time (ST), which can be based on buffer status information. A third option can be to probe those STAs that have the largest product QoS×ST. In these options, the probe period is relatively long (e.g., 100 milliseconds) compared with one PPDU or one burst (e.g., SIFS-burst data transmission can be 8 milliseconds), and the current QoS information or buffer status information may not be able to reflect the long term transmission needed for those STAs.

In order to address the long term transmission needs for STAs described above, two additional options are proposed that can be used for selecting STAs as part of the probing operations described herein. One option involves probing (e.g., selecting to probe) those STAs with the most transmissions in the last probe period. For example, the AP can classify (e.g., order, rank, sort, categorize) STAs based on the number of transmissions in the last probe period and identify those STAs that meet or exceed a specified number of transmissions. The idea being that STAs with the most transmissions contribute most to the throughput and the AP should try to probe more MU-MIMO group sizes, MU-MIMO group combinations, and MCS options for these STAs.

The other option involves probing those STAs with the largest average QoS×T in the last probe period. For example, the AP can classify (e.g., order, rank, sort, categorize) STAs based on the average QoS×T in the last probe period and identify those STAs that meet or exceed a specified average QoS×T value or threshold.

After the STAs are selected, they can be placed into an STA candidates list and ordered or sorted within the list by their transmission frequency or average QoS×T.

In addition to the various approaches described above for selecting STAs, the AP can also follow various approaches for selecting MU-MIMO group size and MCSs for probing.

For example, the AP can probe (e.g., select to probe) MU-MIMO group sizes around (e.g., near or adjacent in size) those MU-MIMO group sizes used since last probing. Because of probing overhead considerations, the number of MU-MIMO group sizes that can be considered candidates for probing may need to be limited. In one aspect, the number of candidate MU-MIMO group sizes can be limited to 3.

In another aspect, if there were a large number of MU-MIMO group sizes used since the last probing, the AP can determine that those MU-MIMO group sizes most frequently used since the last probing can become reference MU-MIMO group sizes and the candidate MU-MIMO group sizes can be determined from the reference ones. For example, the AP can identify the three (3) most frequently used MU-MIMO group sizes and probe three MU-MIMO group sizes adjacent to the frequently used ones. So, if the three most frequently used MU-MIMO group sizes are {3, 5, 6}, the AP can probe (e.g., use as candidates) MU-MIMO group sizes of {2, 4, 7}. In this regard, channel sounding may need to be based on the largest of the MU-MIMO group size candidates.

For a given STA, the probing (e.g., selected for probing) MCSs can also be those around (e.g., near, adjacent) to those most frequently used. A frequently used MCS can be determined based on the last probing or some other time frame. Like MU-MIMO group sizes, the number of candidate MCSs may need to be limited (e.g., 3 candidate MCSs). In one aspect, the AP can determine or identify the most frequently used MCS for a STA to be probed and can assign this MCS as the reference MCS. The candidate MCSs can then include the reference MCS, MCS−1, and MCS+1. For example, if the most frequently used MCS has an index value of x, the candidate MCSs for the STA to be probed are {x−1, x, x+1}.

After the AP (e.g., AP1 105-a or AP2 105-b) determines or selects the candidate STAs, MU-MIMO group sizes, and MCSs to probe, the AP can then make use of historical channel correlation statistics and QoS rank statistics to determine the set of MU-MIMO groups (e.g., MU-MIMO group sizes and members) to probe as part of the probing operations described herein.

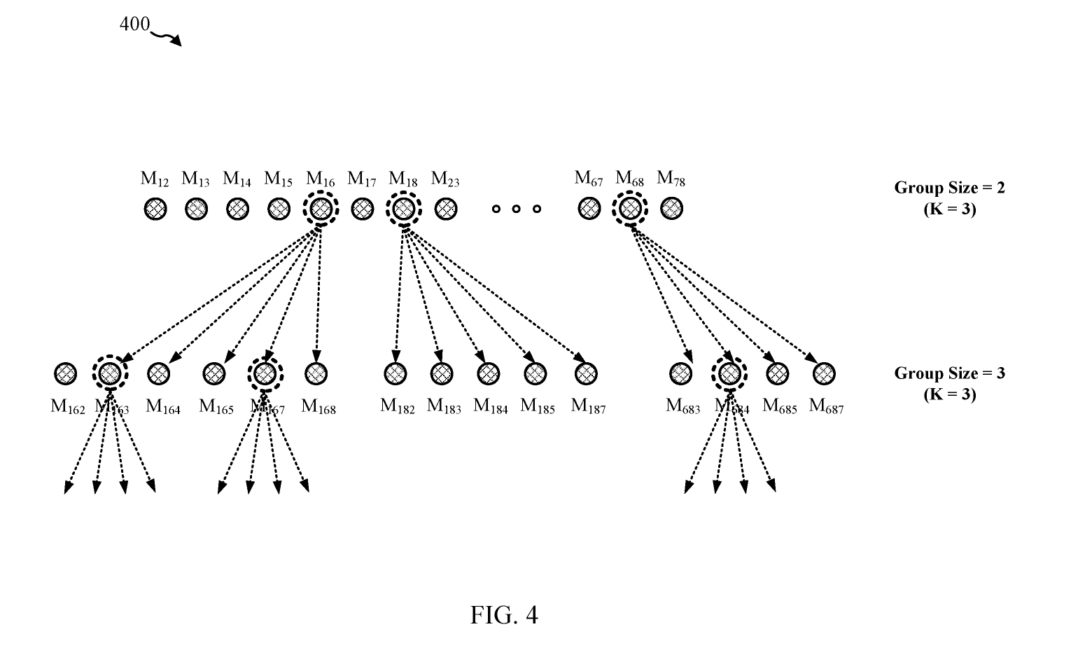

FIG. 4 illustrates a diagram 400 that describes an example of MU-MIMO group selection for the probing operations. The AP can be configured to calculate or determine channel correlation among STAs from, for example, compresses beamforming (CBF) reports (e.g., CBF reports 225 in FIG. 2) for every SIFS-burst transmission. For example, the AP can identify or determine correlation metrics (M) between different STAs based on signal strength metrics (e.g., MU-SINR) resulting from information provided by the CBF reports. The correlation metrics relating to multiple MU-MIMO groups can be used by the AP to detect changes and patterns associated with channel correlation among STAs. Additional details and/or other examples for determining the correlation metrics are described in commonly-owned, co-pending U.S. patent application Ser. No. 14/842,592 (now U.S. Pat. No. 9,590,707) filed on Sep. 1, 2015 and entitled “Using Compressed Beamforming Information for Optimizing Multiple-Input-Multiple-Output Operations,” the contents of which are incorporated here by reference in their entirety.

The correlation metrics can be configured such that the higher the value of the metric is, the less the correlation between STAs. When the correlation between STAs is small, the STAs are less likely to cause interference between them and, therefore, are more likely to be good members of the same MU-MIMO group.

Returning back to FIG. 4, the AP can then calculate, determine, estimate, or otherwise obtain a correlation metric M_{xy} for MU-MIMO groups sizes of two (2) (e.g., correlation metric between STAx and STAy), a correlation metric M_{xyz} for MU-MIMO group sizes of three (3) (e.g., correlation metric between STAx, STAy, and STAz), and so on. That is, each correlation metric identifies a correlation for members of a particular MU-MIMO group. Once the correlation metrics have been determined for MU-MIMO groups sizes of 2 (gs=2) as shown on the top row of correlation metrics in FIG. 4 (e.g., M₁₂, . . . , M₇₈), the AP can select and save the best K metrics (e.g., highest value or lowest correlation). In this example, where K=3, the AP selects and saves correlation metrics M₁₆, M₁₈, and M₆₈ for MU-MIMO group sizes of 2. That is, the AP selects and saves the correlation metrics for MU-MIMO groups {1, 6}, {1, 8}, and {6, 8}.

From the K metrics for MU-MIMO group sizes of 2, the AP then identifies corresponding correlation metrics for MU-MIMO group sizes of 3 (gs=3), as shown on the bottom row of correlation metrics in FIG. 4 (e.g., M₁₆₂, . . . , M₆₈₇). Here again, the AP selects and saves the best K metrics. In this example, where K=3, the AP selects and saves correlation metrics M₁₆₃, M₁₆₇, and M₆₈₄ for MU-MIMO group sizes of 3. That is, the AP selects and saves the correlation metrics for MU-MIMO groups {1, 6, 3}, {1, 6, 7}, and {6, 8, 4}.

The AP can continue this process for the different MU-MIMO group sizes that have been identified as candidate MU-MIMO group sizes for probing.

When the AP needs to probe, for the particular MU-MIMO group size that is to be probed, the AP can order the saved MU-MIMO groups by their saved frequency in the last probing period. Then, starting from the most frequently saved MU-MIMO group, the AP identifies the MU-MIMO group whose members (e.g., STAs) are all part of the STA candidates list. If the AP identifies such an MU-MIMO group, then the AP has identified an MU-MIMO group for probing with the different MCSs in the list of candidate MCSs.

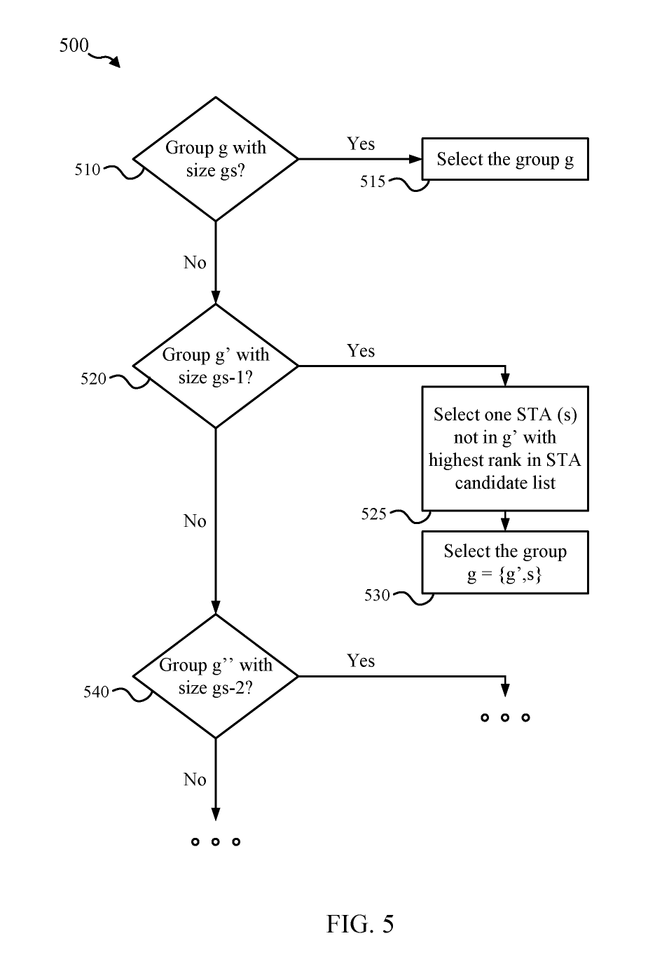

If, on the other hand, the AP is not able to identify an MU-MIMO group whose members are all part of the STA candidates list, then the AP proceeds to identify a smaller MU-MIMO group whose members are all part of the STA candidates list. FIG. 5 illustrates an example of a method 500 performed by the AP during MU-MIMO group selection for the probing operations when the AP is unable to find an MU-MIMO group with STAs from the STA candidates list.

At 510, as described above, the AP determines whether there is an MU-MIMO group (g) of those stored by the AP (starting with the most frequently saved) that has the MU-MIMO group size gs that is to be probed and that has all STAs in the STA candidates list. If such an MU-MIMO group is identified, then the AP selects at 515 the MU-MIMO group for probing. If such an MU-MIMO group is not identified, then the AP proceeds to 520.

At 520, the AP tries finding an MU-MIMO group (g′) with a smaller MU-MIMO group size (gs-1) whose members are all part of the STA candidates list. If such an MU-MIMO group is found, at 525, the AP can pick or select another STA (s) that has the highest rank in the STA candidates list but that is not in g′ for merging with g′. As described above, the STA candidates list can be ordered or sorted by transmission frequency or average QoS×T, therefore, the highest ranked STA can be the one that has the highest transmission frequency or average QoS×T.

At 530, the AP merges the STA selected in 520 with g′ and selects group g={g′, s} for probing.

If at 520 the AP is unable to find an MU-MIMO group (g′) with a smaller MU-MIMO group size (gs-1) whose members are all part of the STA candidates list, then the AP proceeds to 540, where the AP tries finding an MU-MIMO group (g″) with an even smaller MU-MIMO group size (gs-2) whose members are all part of the STA candidates list. This process can continue until an MU-MIMO group with size gs is formed by the AP.

With the various techniques described above, the AP can then perform the probing operations described herein by using a more effective set of MU-MIMO groups and thus reduce the probing overhead that would otherwise be needed if all possible combinations of MU-MIMO groups were to be considered. The AP therefore has a set of MU-MIMO groups, along with the different MCSs and STAs to be used for packet error probing and to update the packet error information stored in the AP such that MU-MIMO grouping operations for data transmission can be more effectively performed.

Another aspect of this disclosure involves the use of the packet error metric updates obtained from the probing operations to perform heuristic packet error metric updates for the MU-MIMO group sizes and MCSs that were not part of the probing operations (e.g., non-probed MU-MIMO group size, non-probed MCS). As used herein, heuristics can refer to techniques or methods for finding approximate or sufficiently accurate results from available information.

For example, for a probed STA (e.g., an STA probed as part of the probing operations described above), the packet error metrics (e.g., PER) can also be updated for its corresponding non-probed MU-MIMO group sizes and non-probed MCSs. To do so, the AP can implement techniques or methods that are based on the monotonicity of MU-MIMO group sizes and MCSs.

Because of the monotonicity of MCS, the techniques or methods implemented by the AP to update non-probed MCSs can rely on the following conditions (assuming the packet error metric being PER) in equations (2) and (3):

for mcs<MCS updated,

PER_{updated}(mcs)=MIN(PER(mcs),PER_{updated}(MCS)), (2)

for mcs>MCS updated,

PER_{updated}(mcs)=MAX(PER(mcs),PER_{updated}(MCS)), (3)

where mcs is a non-probed MCS, MCS updated is a probed MCS, PER_{updated}(MCS) is the updated PER for the probed MCS, PER_{updated}(mcs) is the updated PER for the non-probed MCS, and PER(mcs) is the PER for the non-probed MCS prior to being updated. The above conditions follow from the concept that a smaller MCS is likely to produce a smaller PER than a larger MCS.

Similarly, because of the monotonic characteristics (e.g., either non-decreasing or non-increasing characteristics) of MU-MIMO group sizes, the techniques or methods implemented by the AP to update non-probed MU-MIMO group sizes can rely on the following conditions (assuming the packet error metric being PER) in equations (4) and (5):

for gs<GS updated,

PER_{updated}(gs)=MIN(PER(gs),PER_{updated}(GS)), (4)

for gs>GS updated,

PER_{updated}(gs)=MAX(PER(gs),PER_{updated}(GS)), (5)

where gs is a non-probed MU-MIMO group size, GS updated is a probed MU-MIMO group size, PER_{updated}(GS) is the updated PER for the probed MU-MIMO group size, PER_{updated}(gs) is the updated PER for the non-probed MU-MIMO group size, and PER(gs) is the PER for the non-probed MU-MIMO group size prior to being updated. The above conditions follow from the concept that a smaller MU-MIMO group size is likely to produce less interference among members of the group than a larger MU-MIMO group sizes.

When the channel is considered good (e.g., meets a certain packet error metric level, a certain signal strength metric level, or both), it may be possible to increase the MU-MIMO group size and MCS to give those new values a chance for transmission.

For example, probing may have been done for an MU-MIMO group size (gs) and an MCS (mcs). In such a case, and when the channel is good (e.g., low PER), the probed_PER(mcs, gs)<PER_threshold, and the PER(mcs, gs) that has not yet been updated can also be smaller than PER_threshold (e.g., PER(mcs, gs)<PER_threshold). In some implementations, PER_threshold can be, for example, 0.1% or 0.2%. The AP can then update the PER as in equation (6):

PER_{updated}(mcs,gs)=PER(mcs,gs)×α+probed_PER(mcs,gs)×(1−α), (6)

where α is a weighting factor and 0≤α≤1. In some implementations, α can be 0.7, 0.8, or 0.9.

If the AP determines that PER(mcs+1, gs), that is, the yet to be updated PER for an MU-MIMO group size of gs and an MCS of mcs+1, is greater than PER_threshold (e.g., PER(mcs+1, gs)>PER_threshold), the AP can update PER(mcs+1, gs) based on PER_threshold as shown below in equation (7):

PER_{updated}(mcs+1,gs)=PER(mcs+1,gs)×α+PER_threshold×(1−α). (7)

Similarly, if the AP determines that gs is small (e.g., gs<gs_threshold, where gs_threshold=2, 3, or 4) and that PER(mcs, gs+1), that is, the yet to be updated PER for an MU-MIMO group size of gs+1 and an MCS of mcs, is greater than PER_threshold (e.g., PER(mcs, gs+1)>PER_threshold), the AP can update PER(mcs, gs+1) based on PER_threshold as shown below in equation (8):

PER_{updated}(mcs,gs+1)=PER(mcs,gs+1)×α+PER_threshold×(1−α). (8)

The examples provided above for various heuristics that can be used have been described in connection with updating PER information, however, such heuristics can also be similarly used with any type of packet error metric.

By using the heuristics described above, an AP can update packet error metrics for many non-probed MU-MIMO group sizes as well as many non-probed MCSs.

FIG. 6 illustrates an example of hardware implementation of an AP 105 (e.g., AP1 105-a or AP2 105-b in FIG. 1) that can be employed within a wireless communication system to perform the proposed MU-MIMO rate adaptation mechanism described in connection with the scenarios or conditions discussed above. The hardware components and subcomponents of the AP 105 can be used to implement one or more methods (e.g., methods 500, 800, and 900) described herein. For example, one example of an implementation of AP 105 can include a variety of components, some of which have already been described above, but including components such as one or more processors 612, memory 616, and transceiver 602 in communication via one or more buses 674, which may operate in conjunction with the communications component 150 to enable one or more of the functions described herein related to grouping in MU-MIMO systems with limited probing. Further, the one or more processors 612, which include a modem 614, memory 616, transceiver 602, RF front end 688 and one or more antennas 665, may be configured to support voice and/or data calls (simultaneously or non-simultaneously) in one or more radio access technologies (RATs).

In an aspect, the one or more processors 612 can include the modem 614 that uses one or more modem processors. The various functions related to the communications component 150 can be included in modem 614 and/or processors 612 and, in an aspect, can be executed by a single processor, while in other aspects, different ones of the functions may be executed by a combination of two or more different processors. For example, in an aspect, the one or more processors 612 can include any one or any combination of a modem processor, or a baseband processor, or a digital signal processor, or a transmit processor, or a receiver processor, or a transceiver processor associated with transceiver 602. In other aspects, some of the features of the one or more processors 612 and/or modem 614 associated with the communications component 150 can be performed by transceiver 602.

Also, memory 616 can be configured to store data and/or instructions used herein, local versions of applications 675, and/or local versions of the communications component 150, including one or more of its subcomponents being executed by at least one processor 612. Memory 616 can include any type of computer-readable medium usable by a computer or at least one processor 612, such as random access memory (RAM), read only memory (ROM), tapes, magnetic discs, optical discs, volatile memory, non-volatile memory, and any combination thereof. In an aspect, for example, memory 616 may be a non-transitory computer-readable storage medium that stores one or more computer-executable codes defining the communications component 150 and/or one or more of its subcomponents, and/or data associated therewith, when AP 105 is operating at least one processor 612 to execute the communications component 150 and/or one or more of its subcomponents.

Transceiver 602 can include at least one receiver 806 and at least one transmitter 608. Receiver 606 can include hardware, firmware, and/or software code executable by a processor for receiving data, the code comprising instructions and being stored in a memory (e.g., computer-readable medium). Receiver 606 can be, for example, a radio frequency (RF) receiver. In an aspect, receiver 806 can receive signals transmitted by at least one STA 115. Additionally, receiver 606 can process such received signals, and also may obtain measurements of the signals, such as, but not limited to, Ec/Io, SNR, SINR, MU-SINR, RSRP, RSSI, etc. Transmitter 608 can include hardware, firmware, and/or software code executable by a processor for transmitting data, the code comprising instructions and being stored in a memory (e.g., computer-readable medium). A suitable example of transceiver 602 can include, but is not limited to, an RF transmitter.

Moreover, in an aspect, AP 105 can include RF front end 688, which can operate in communication with one or more antennas 665 and transceiver 602 for receiving and transmitting radio transmissions, for example, wireless communications transmitted by at least one STA 115 or wireless transmissions transmitted by AP 105. RF front end 688 can be connected to one or more antennas 665 and can include one or more low-noise amplifiers (LNAs) 690, one or more switches 692, one or more power amplifiers (PAs) 698, and one or more filters 696 for transmitting and receiving RF signals.

In an aspect, LNA 690 can amplify a received signal at a desired output level. In an aspect, each LNA 690 can have a specified minimum and maximum gain values. In an aspect, RF front end 688 can use one or more switches 892 to select a particular LNA 690 and its specified gain value based on a desired gain value for a particular application.

Further, for example, one or more PA(s) 698 can be used by RF front end 688 to amplify a signal for an RF output at a desired output power level. In an aspect, each PA 698 can have specified minimum and maximum gain values. In an aspect, RF front end 688 can use one or more switches 692 to select a particular PA 698 and its specified gain value based on a desired gain value for a particular application.

Also, for example, one or more filters 696 can be used by RF front end 688 to filter a received signal to obtain an input RF signal. Similarly, in an aspect, for example, a respective filter 696 can be used to filter an output from a respective PA 698 to produce an output signal for transmission. In an aspect, each filter 696 can be connected to a specific LNA 690 and/or PA 698. In an aspect, RF front end 688 can use one or more switches 692 to select a transmit or receive path using a specified filter 696, LNA 690, and/or PA 698, based on a configuration as specified by transceiver 602 and/or processor 612.

As such, transceiver 602 can be configured to transmit and receive wireless signals through one or more antennas 665 via RF front end 688. In an aspect, transceiver 802 can be tuned to operate at specified frequencies such that AP 105 can communicate with, for example, one or more STAs 115 or one or more cells associated with one or more APs 105. In an aspect, for example, modem 814 can configure transceiver 602 to operate at a specified frequency and power level based on the AP configuration of the AP 105 and the communication protocol used by modem 614.

In an aspect, modem 614 can be a multiband-multimode modem, which can process digital data and communicate with transceiver 602 such that the digital data is sent and received using transceiver 602. In an aspect, modem 614 can be multiband and be configured to support multiple frequency bands for a specific communications protocol. In an aspect, modem 614 can be multimode and be configured to support multiple operating networks and communications protocols. In an aspect, modem 614 can control one or more components of AP 105 (e.g., RF front end 688, transceiver 602) to enable transmission and/or reception of signals from the network based on a specified modem configuration. In an aspect, the modem configuration can be based on the mode of the modem 614 and the frequency band in use. In another aspect, the modem configuration can be based on AP configuration information associated with AP 105 as provided by the network during cell selection and/or cell reselection.

In some examples, the communications component 150 can include a scheduler component 620, a channel sounding component 625, a data transmission component 630, a probing component 640, and a packet error metrics component 650. The probing component 640 can include a trigger component 641, which in turn can include a timer 642, an embedding component 643, a candidates component 644, a group selection component 645, and a heuristics component 646.

The scheduler component 620 can be configured to schedule MU-MIMO communications, including scheduling various MU-MIMO groups for transmission using PPDUs. The scheduler component 620 can operate in connection with, for example, the probing component 640 and/or the data transmission component 630 to identify the MU-MIMO groups and/or MCSs to be used for MU-MIMO communications.

The channel sounding component 625 can be configured to perform channel sounding operations, including aspects of the channel sounding sequence described above with respect to FIG. 2. The channel sounding component 625 can operate in connection with the probing component 640 to, for example, coordinate that channel sounding for STAs to be included in probing packets.

The data transmission component 630 can be configured to coordinate data transmission such as those associated with the SIFS-burst data transmissions described above with respect to FIG. 2.

The probing component 640 can be configured to perform probing operations, including the various aspects described herein for reducing probing overhead. For example, the probing component 640 can perform various aspects described herein for embedding or merging the probing operations into a regular SIFS-burst data transmission process, selecting MU-MIMO groups and MU-MIMO group sizes that can be optimal for probing, using channel correlation to reduce the pool or set of candidate MU-MIMO groups for probing, and/or performing heuristics to update packet error metrics for non-probed MU-MIMO groups sizes and non-probed MCSs.

The trigger component 641 can be configured to identify or detect triggers that indicate the start of a probing operation. The trigger component 641 can be configured to identify or detect the types of triggers described above with respect to FIG. 3. The timer 642 in the trigger component 641 can be used to schedule the probing interval triggers. The trigger component 641 can also be configured to perform mechanisms to preempt or override the interval-based or interval-driven triggering of probing operations.

The embedding component 643 can be configured to embed or merge probing operations into a SIFS-burst data transmission process as shown in FIG. 2. The embedding component 643 can coordinate the embedding or merging of the probing operations with the scheduler component 620 and/or the data transmission component 630.

The candidates component 644 can be configured to perform the various aspects described above to select a set of candidate STAs, a set of candidate MU-MIMO group sizes, and a set of candidate MCSs. For example, the candidates component 644 can perform various options for classifying STAs and produce an STA candidates list. The candidates component 644 can also determine candidate MU-MIMO group sizes based on reference MU-MIMO group sizes, and candidate MCSs based on reference MCSs.

The group selection component 645 can be configured to identify MU-MIMO groups for probing. The group selection component 645 can be used to implement aspects of the MU-MIMO group selection as described above with respect to FIGS. 4 and 5. For example, the group selection component 645 can perform aspects related to the use of channel correlation for the selection of MU-MIMO groups for probing.

The heuristics component 646 can be configured to implement various aspects described above for using heuristics to update packet error metrics for non-probed MU-MIMO group sizes and/or non-probed MCSs. The heuristics component 646 can coordinate the heuristics operations with the packet error metrics updates performed by the packet error metrics component 650. In this regard, the packet error metrics component 650 can be configured to update packet error metrics (e.g., PER) based on feedback received from the probing operations and/or other operations, including operations performed during data transmission. The packet error metrics component 650 can include one or more tables (not shown) that contain the packet error metrics information.

FIG. 7 illustrates an example of hardware implementation of an STA 115 (e.g., STA2 115-b in FIG. 1) that may be employed within a wireless communication system in which an AP is configured to perform the proposed MU-MIMO rate adaptation mechanism described in connection with the scenarios or conditions discussed above. The hardware components and subcomponents of the STA 115 can be used to communicate with the AP. An implementation of the STA 115 can include a variety of components, some of which have already been described above. For example, the STA 115 can include one or more processors 712 having a modem 714, a memory 716 having applications 775, a transceiver 702 having a receiver 706 and a transmitter 708, an RF front end 788 having LNAs 790, switches 792, filters 796, and Pas 798. These components can communicate with each other through one or more buses 744. Moreover, these components can generally operate in a similar manner as corresponding components and subcomponents described above with respect to FIG. 6.

The communications component 160, which can be implemented in the one or more processors 712 and/or as part of the modem 714, can include a channel sounding component 720. The channel sounding component 720 can be configured to enable the operations or functions performed by an STA during the channel sounding sequence. For example, the channel sounding component 720 can receive NDPAs (e.g., NDPA 210), NDPs (e.g., NDP 215), and CBF triggers (e.g., CTs 220) from an AP, and can process those packets as described above in connection with FIG. 2. Moreover, the channel sounding component 720 can transmit a CBF report (e.g., CBF reports 225) back to AP to provide channel information that the AP can use for beamforming operations. The communications component 160 can also be configured to provide block acknowledgments (e.g., BAs 240, 255, and 270) in connection with probing packets (e.g., probing packets 230, 245) and data packets (e.g., data packet 260).

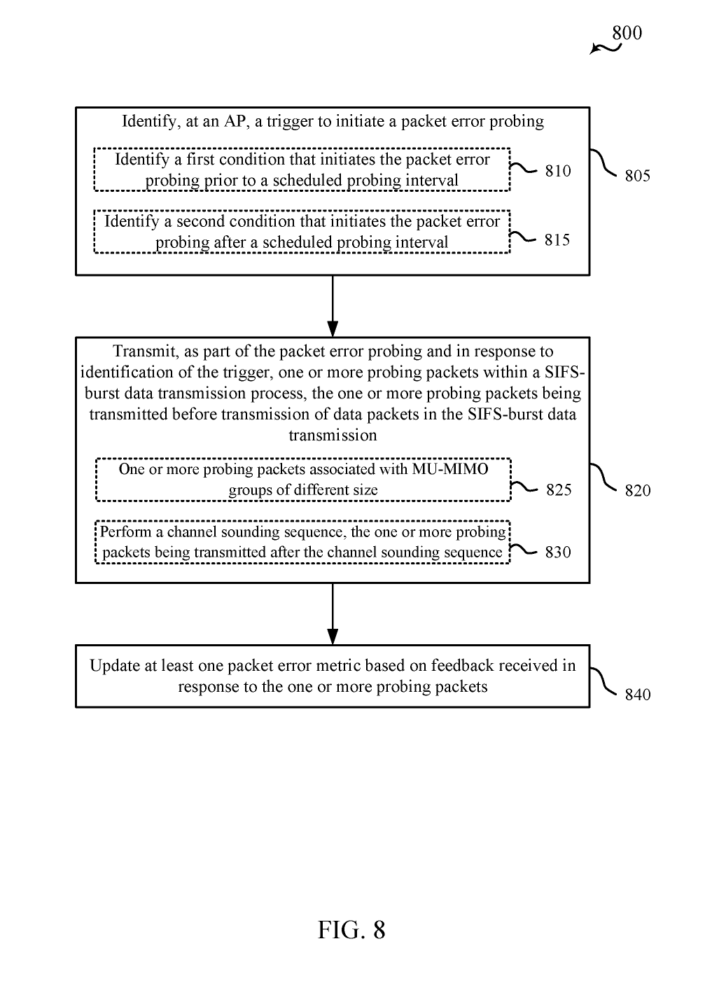

FIG. 8 illustrates an example of a method 800 for wireless communications implemented on an AP (e.g., AP1 105-a or AP2 105-b in FIG. 1).

At 805, an AP can identify a trigger to initiate a packet error probing or probing operation. The trigger identification can be as described above with respect to FIG. 3. Moreover, in an aspect, the processor 612, the modem 614, the communications component 150, the probing component 640, and/or the trigger component 641 can be used for identifying the trigger and indicating to other components to initiate a probing operation.

Optionally in 805, at 810, the AP can identify a first condition that initiates the packet error probing prior to a scheduled probing interval. For example, the AP can identify a condition that can accelerate the probing operation such that the AP need not wait until the next scheduled probing interval trigger. Optionally in 805, at 815, the AP can identify a second condition, different from the first condition in 810, that initiates the packet error probing after a scheduled probing interval. For example, the AP can identify a condition that can postpone the probing operation such that the AP need not initiate a probing operation at the next scheduled probing interval trigger.

At 820, the AP can transmit, as part of the packet error probing and in response to the identification of the trigger, one or more probing packets within a SIFS-burst data transmission process, where the one or more probing packets are transmitted before transmission of data packets in the SIFS-burst data transmission process. The transmission of probing packets can be as described above with respect to FIG. 2. Moreover, in an aspect, the processor 612, the modem 614, the communications component 150, the probing component 640, the embedding component 643, the transceiver 602, and/or the RF front end 688 can be used for transmitting probing packets (e.g., probing packets 230, 245) within the SIFS-burst data transmission process.

At 825, the one or more probing packets are used for probing different MU-MIMO group sizes by having each probing packet associated with MU-MIMO groups of a different size.

At 830, the AP can perform a channel sounding sequence, where the one or more probing packets are transmitted after the channel sounding sequence. The channel sounding sequence is described above with respect to FIG. 2 and the channel sounding component 625 can perform aspects related to the channel sounding sequence.

At 840, the AP can update at least one packet error metric based on feedback received in response to the one or more probing packets. In an aspect, the processor 612, the modem 614, the communications component 150, the probing component 640, the heuristics component 646, and/or the packets error metrics component 650 can be used to update packet error metric information, such as PER, for example.

In another aspect of the method 800, the AP can receive an indication that one of the one or more probing packets failed and the AP can perform the transmission of the data packets in the SIFS-burst data transmission process even after receiving the indication. Thus, in contrast to the burst termination that would occur if a data packet fails, the failure of a probing packet does not terminate the burst.

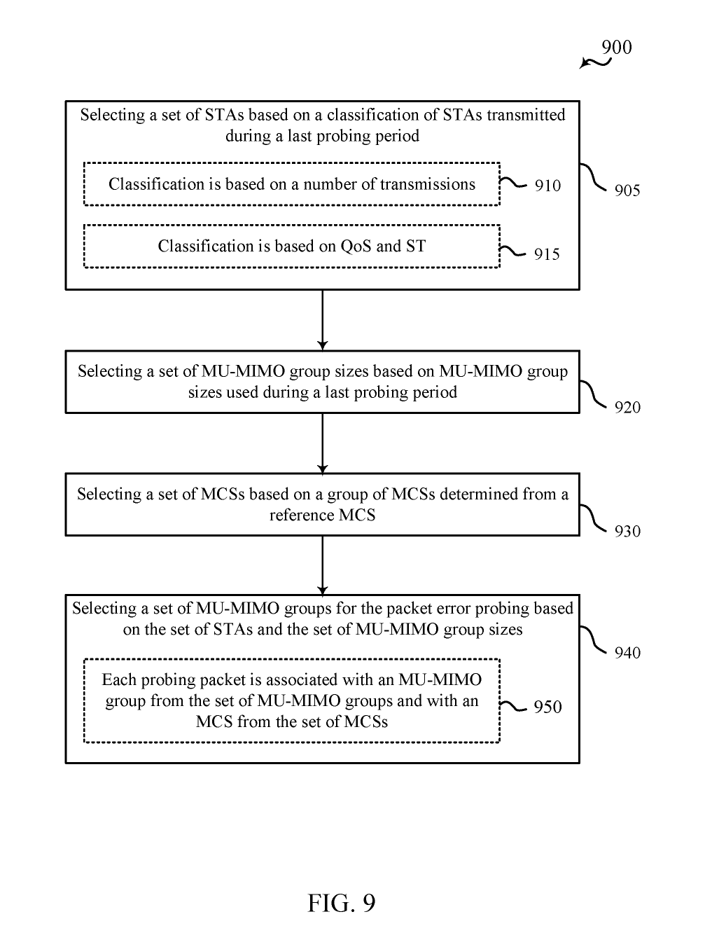

FIG. 9 illustrates an example of a method 900 for wireless communications implemented on an AP (e.g., AP1 105-a or AP2 105-b).

At 905, the AP can select a set of STAs based on a classification of STAs transmitted during a last probing period. The AP can then place the selected STAs into an STA candidates list. In an aspect, the processor 612, the modem 614, the communications component 150, the probing component 640, and/or the candidates component 644 can be used to select the set of STAs that will be included in the STA candidates list.

Optionally in 905, at 910, the AP (e.g., the candidates component 644) can classify the STAs based on a number of transmissions in a last probe period. In this case, the STAs included in the STA candidates list can be ordered within the list based on the transmission frequency (e.g., number of transmissions).

Also optionally in 905, at 915, the AP (e.g., the candidates component 644) can classify the STAs based on QoS and scheduled transmission time (ST) in a last probe period. For example the STAs can be classified based on the average of a product of QoS and ST (e.g., QoS×ST). In this case, the STAs included in the STA candidates list can be ordered within the list based on the average QoS×ST.

At 920, the AP can select a set of MU-MIMO group sizes based on MU-MIMO group sizes used during a last probe period. For example, the AP can identify reference MU-MIMO group sizes and select MU-MIMO group sizes around (e.g., adjacent) those of the reference MU-MIMO group sizes. In some cases, the selection may be limited to a pre-determined number of MU-MIMO group sizes. In an aspect, the processor 612, the modem 614, the communications component 150, the probing component 640, and/or the candidates component 644 can be used to select the set of MU-MIMO group sizes.

At 930, the AP can select a set of MCSs based on a group of MCSs determined from a reference MCS. In some cases, the selection may be limited to a pre-determined number of MCSs. In an aspect, the processor 612, the modem 614, the communications component 150, the probing component 640, and/or the candidates component 644 can be used to select the set of MCSs.

At 940, the AP can select a set of MU-MIMO groups for the packet error probing (e.g., probing operations) based on the set of STAs and the set of MU-MIMO group sizes. Aspects of the selection of the set of MU-MIMO groups are described above with respect to FIGS. 4 and 5, and can include the use of channel correlation statistics, for example. Moreover, in an aspect, the processor 612, the modem 614, the communications component 150, the probing component 640, and/or the group selection component 645 can be used to select the set of MU-MIMO groups.

Optionally in 940, at 950, the AP can then use the set of MU-MIMO groups and associate each probing packet (e.g., probing packet 230, 245 in FIG. 2) with one of the MU-MIMO groups and one of the MCSs from 930.

Aspects of the present hardware implementations (e.g., FIGS. 6 and 7) and methods (e.g., FIGS. 5, 8, and 9) are depicted with reference to one or more components or subcomponents, and one or more methods, which can perform the actions or functions described herein. Although the operations or methods described above are presented in a particular order and/or as being performed by an example component, it should be understood that the ordering of the actions and the components performing the actions may be varied, depending on the implementation. In addition, aspects of any one of the methods described above can be combined with aspects of any other of the methods. For example, the packet error probing functions described in the method 800 of FIG. 8 can be combined with one or more of the selection functions described in the method 900 of FIG. 9.

Moreover, it should be understood that the actions or functions can be performed by a specially-programmed or specially-configured processor, a processor executing specially-programmed software or computer-readable media, or by any other combination of a hardware component and/or a software component capable of performing the described actions or functions. Moreover, in an aspect, a component may be one of the parts that make up a system, may be hardware or software, and/or may be divided into other components (e.g., subcomponents).

By way of example, an element or component, or any portion of an element or component, or any combination of elements or components can be implemented with a “processing system” that includes one or more processors. A processor can include a general purpose processor, a digital signal processor (DSP), an application specific integrated circuit (ASIC), a field programmable gate array (FPGA) or other programmable logic component, discrete gate or transistor logic, discrete hardware components, or any combination thereof, or any other suitable component designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP, or any other such configuration.

One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on transitory or non-transitory computer-readable medium. A non-transitory computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), static RAM (SRAM), dynamic RAM (DRAM), synchronous dynamic RAM (SDRAM); double date rate RAM (DDRAM), read only memory (ROM), programmable ROM (PROM), erasable PROM (EPROM), electrically erasable PROM (EEPROM), a general register, or any other suitable non-transitory medium for storing software.

The various interconnections within a processing system may be shown as buses or as single signal lines. Each of the buses may alternatively be a single signal line, and each of the single signal lines may alternatively be buses, and a single line or bus might represent any one or more of a myriad of physical or logical mechanisms for communication between elements. Any of the signals provided over various buses described herein may be time-multiplexed with other signals and provided over one or more common buses.

The various aspects of this disclosure are provided to enable one of ordinary skill in the art to practice the present disclosure. Various modifications to examples of implementations presented throughout this disclosure will be readily apparent to those skilled in the art, and the concepts disclosed herein may be extended to other devices, systems, or networks. Thus, the claims are not intended to be limited to the various aspects of this disclosure, but are to be accorded the full scope consistent with the language of the claims. All structural and functional equivalents to the various components of the examples of implementations described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for.”

What is claimed is:

1. A method of multi-user multiple-input-multiple-output (MU-MIMO) communications, comprising:
identifying, at an access point (AP), a trigger to initiate a packet error probing;
transmitting, as part of the packet error probing and in response to the identification of the trigger, one or more probing packets within a short interframe space (SIFS)-burst data transmission process, the one or more probing packets being transmitted before transmission of data packets in the SIFS-burst data transmission process; and
updating at least one packet error metric based on feedback received in response to the one or more probing packets.

2. The method of claim 1, wherein transmitting the one or more probing packets includes transmitting the one or more probing packets after a channel sounding sequence performed as part of the SIFS-burst data transmission process.

3. The method of claim 1, wherein the one or more probing packets include:
a first probing packet associated with a first MU-MIMO group, and
a second probing packet associated with a second MU-MIMO group different in size from the first MU-MIMO group.

4. The method of claim 3, further comprising:
performing a channel sounding sequence for multiple wireless stations (STAs) as part of the SIFS-burst data transmission process, the transmission of the one or more probing packets being after the performance of the channel sounding sequence,
wherein the first MU-MIMO group is associated with a first subset of the multiple STAs,
wherein the second MU-MIMO group is associated with a second subset of the multiple STAs, and
wherein the transmission of data packets includes the transmission of at least one data packet associated with a third subset of the multiple STAs.

5. The method of claim 1, further comprising:
receiving an indication that one of the one or more probing packets failed; and
performing the transmission of the data packets in the SIFS-burst data transmission process even after receiving the indication.

6. The method of claim 1, wherein identifying the trigger includes:
identifying a first condition that initiates the packet error probing prior to a scheduled probing interval, or
identifying a second condition that initiates the packet error probing after the scheduled start on the probing interval.

7. The method of claim 1, further comprising:
selecting a set of STAs, a set of MU-MIMO group sizes, and a set of modulation coding schemes (MCSs) for the packet error probing,
wherein the at least one packet error metric is updated based on a respective STA from the set of STAs, a respective MU-MIMO group size from the set of MU-MIMO group sizes, and a respective MCS from the set of MCSs, and
wherein each of the one or more probing packets is associated with a subset of the set of STAs and one of the set of MU-MIM group sizes.

8. The method of claim 7, wherein selecting the set of STAs includes:
classifying STAs transmitted during a probing period between a start of a previous packet error probing and a start of the packet error probing, the classification being based on a number of times of each of the STAs is transmitted during the probing period; and
selecting the set of STAs based at least in part on the classification.

9. The method of claim 7, wherein selecting the set of STAs includes:
classifying STAs transmitted during a probing period between a start of a previous packet error probing and a start of the packet error probing, the classification being based on a quality-of-service metric and a scheduled transmission time for each of the STAs transmitted during the probing period; and
selecting the set of STAs based at least in part on the classification.

10. The method of claim 7, wherein selecting the set of MU-MIMO group sizes includes:
identifying MU-MIMO group sizes used during a probing period between a start of a previous packet error probing and a start of the packet error probing; and
selecting as the set of MU-MIMO group sizes two or more MU-MIMO group sizes different from the MU-MIMO group sizes used during the probing period.

11. The method of claim 7, wherein selecting the set of MCSs includes:
identifying, for each STA in the set of STAs, a reference MCS;
determining, for each STA in the set of STAs, a group of MCSs based on the reference MCS; and
selecting the set of MCSs based at least in part on the group of MCSs for each of the STAs in the set of STAs.

12. The method of claim 7, further comprising:
selecting, based at least in part on the set of STAs and the set of MU-MIMO group sizes, a set of MU-MIMO groups for use in the packet error probing, the selecting being based at least in part on channel correlation statistics among the set of STAs,
wherein each of the one or more probing packets is associated with an MU-MIMO group from the set of MU-MIMO groups and with an MCS from the set of MCSs.

13. The method of claim 12, further comprising:
identifying, for each STA associated with the set of MU-MIMO groups for use in the packet error probing, one or more MCSs and one or more MU-MIMO group sizes that were not probed along with the respective STA,
wherein updating the at least one packet error metric includes updating, each STA associated with the set of MU-MIMO groups for use in the packet error probing, a packet error metric associated with the one or more MCSs and one or more MU-MIMO group sizes that were not probed along with the respective STA, the updating being based on monotonicity of MCS and MU-MIMO group size.

14. The method of claim 12, wherein the updating of the packet error metric associated with the one or more MCSs and one or more MU-MIMO group sizes that were not probed along with the respective STA is based on a weighting parameter and a packet error rate threshold.

15. An apparatus for multi-user multiple-input-multiple-output (MU-MIMO) communications, comprising:
a memory that stores MU-MIMO communications instructions; and
a processor coupled with the memory, and configured to execute the MU-MIMO communications instructions to:
identify, at an access point (AP), a trigger to initiate a packet error probing;
transmit, as part of the packet error probing and in response to the identification of the trigger, one or more probing packets within a short interframe space (SIFS)-burst data transmission process, the one or more probing packets being transmitted before transmission of data packets in the SIFS-burst data transmission process; and
update at least one packet error metric based on feedback received in response to the one or more probing packets.

16. The apparatus of claim 15, wherein the processor is configured to execute the MU-MIMO communications instructions to transmit the one or more probing packets by transmitting the one or more probing packets after a channel sounding sequence performed as part of the SIFS-burst data transmission process.

17. The apparatus of claim 15, wherein the one or more probing packets include:
a first probing packet associated with a first MU-MIMO group, and
a second probing packet associated with a second MU-MIMO group different in size from the first MU-MIMO group.

18. The apparatus of claim 17, where in the processor is further configured to execute the MU-MIMO communications instructions to:
perform a channel sounding sequence for multiple wireless stations (STAs) as part of the SIFS-burst data transmission process, the transmission of the one or more probing packets being after the performance of the channel sounding sequence,
wherein the first MU-MIMO group is associated with a first subset of the multiple STAs,
wherein the second MU-MIMO group is associated with a second subset of the multiple STAs, and
wherein the transmission of data packets includes the transmission of at least one data packet associated with a third subset of the multiple STAs.

19. The apparatus of claim 15, wherein the processor is further configured to execute the MU-MIMO communications instructions to:
receive an indication that one of the one or more probing packets failed; and
perform the transmission of the data packets in the SIFS-burst data transmission process even after receiving the indication.

20. The apparatus of claim 15, wherein the processor is configured to identify the trigger by executing the MU-MIMO communications instructions to:
identify a first condition that initiates the packet error probing prior to a scheduled probing interval, or
identify a second condition that initiates the packet error probing after the scheduled start on the probing interval.

21. The apparatus of claim 15, wherein the processor is further configured to execute the MU-MIMO communications instructions to:
select a set of STAs, a set of MU-MIMO group sizes, and a set of modulation coding schemes (MCSs) for the packet error probing,
wherein the at least one packet error metric is updated based on a respective STA from the set of STAs, a respective MU-MIMO group size from the set of MU-MIMO group sizes, and a respective MCS from the set of MCSs, and
wherein each of the one or more probing packets is associated with a subset of the set of STAs and one of the set of MU-MIM group sizes.

22. The apparatus of claim 21, wherein the processor is configured to select the set of STAs by executing the MU-MIMO communications instructions to:
classify STAs transmitted during a probing period between a start of a previous packet error probing and a start of the packet error probing, the classification being based on a number of times of each of the STAs is transmitted during the probing period; and
select the set of STAs based at least in part on the classification.

23. The apparatus of claim 21, wherein the processor is configured to select the set of STAs by executing the MU-MIMO communications instructions to:
classify STAs transmitted during a probing period between a start of a previous packet error probing and a start of the packet error probing, the classification being based on a quality-of-service metric and a scheduled transmission time for each of the STAs transmitted during the probing period; and
select the set of STAs based at least in part on the classification.

24. The apparatus of claim 21, wherein the processor is configured to select the set of MU-MIMO group sizes by executing the MU-MIMO communications instructions to:
identify MU-MIMO group sizes used during a probing period between a start of a previous packet error probing and a start of the packet error probing; and
select as the set of MU-MIMO group sizes two or more MU-MIMO group sizes different from the MU-MIMO group sizes used during the probing period.

25. The apparatus of claim 21, wherein the processor is configured to select the set of MCSs by executing the MU-MIMO communications instructions to:
identify, for each STA in the set of STAs, a reference MCS;
determine, for each STA in the set of STAs, a group of MCSs based on the reference MCS; and
select the set of MCSs based at least in part on the group of MCSs for each of the STAs in the set of STAs.

26. The apparatus of claim 21, wherein the processor is further configured to execute the MU-MIMO communications instructions to:
select, based at least in part on the set of STAs and the set of MU-MIMO group sizes, a set of MU-MIMO groups for use in the packet error probing, the selecting being based at least in part on channel correlation statistics among the set of STAs,
wherein each of the one or more probing packets is associated with an MU-MIMO group from the set of MU-MIMO groups and with an MCS from the set of MCSs.

27. The apparatus of claim 26, wherein the processor is further configured to execute the MU-MIMO communications instructions to:
identify, for each STA associated with the set of MU-MIMO groups for use in the packet error probing, one or more MCSs and one or more MU-MIMO group sizes that were not probed along with the respective STA,
wherein the processor is configured to update the at least one packet error metric by updating, each STA associated with the set of MU-MIMO groups for use in the packet error probing, a packet error metric associated with the one or more MCSs and one or more MU-MIMO group sizes that were not probed along with the respective STA, the updating being based on monotonicity of MCS and MU-MIMO group size.

28. The apparatus of claim 26, wherein the processor is configured to update the packet error metric associated with the one or more MCSs and one or more MU-MIMO group sizes that were not probed along with the respective STA based on a weighting parameter and a packet error rate threshold.

29. An apparatus for multi-user multiple-input-multiple-output (MU-MIMO) communications, comprising:
means for identifying, at an access point (AP), a trigger to initiate a packet error probing;
means for transmitting, as part of the packet error probing and in response to the identification of the trigger, one or more probing packets within a short interframe space (SIFS)-burst data transmission process, the one or more probing packets being transmitted before transmission of data packets in the SIFS-burst data transmission process; and
means for updating at least one packet error metric based on feedback received in response to the one or more probing packets.

30. A computer-readable medium storing executable code for multi-user multiple-input-multiple-output (MU-MIMO) communications, comprising:
code for identifying, at an access point (AP), a trigger to initiate a packet error probing;
code for transmitting, as part of the packet error probing and in response to the identification of the trigger, one or more probing packets within a short interframe space (SIFS)-burst data transmission process, the one or more probing packets being transmitted before transmission of data packets in the SIFS-burst data transmission process; and
code for updating at least one packet error metric based on feedback received in response to the one or more probing packets.
